(19) United States
(12) Patent Application Publication
(10) Pub. No.: US 2024/0177098 A1
(43) Pub. Date: May 30, 2024

(54) USER INTERFACES WITH AUTO-POPULATION TOOLS FOR TIME TRACKING USING MOBILE DEVICES

(71) Applicant: INTUIT INC., Mountain View, CA (US)

(72) Inventor: Andrew MALIWAUKI, Mountain View, CA (US)

(73) Assignee: INTUIT INC., Mountain View, CA (US)

(21) Appl. No.: 18/059,972

(22) Filed: Nov. 29, 2022

(51) Int. Cl. G06Q 10/0639

(52) U.S. Cl. CPC G06Q 10/06393

(57) ABSTRACT

A mobile device application for time tracking provides a dynamic display that auto-populates descriptions (e.g., a job description, a task description) for the hours to be entered. For instance, when a user clocks-in using the application, an auto-population engine executed by the mobile device analyzes the history of time entries by the user and generates a list of likely descriptions for the current entry. The list is displayed as selectable objects. When the user selects an object, the corresponding description is automatically added for the current time entry. The generated list may be based on information associated with the current time entry (e.g., time of day, location, etc.) and historical patterns of time entries. One or more machine learning models may be used to learn the historical patterns.

### BACKGROUND

This is an era of ubiquitous mobile computing. A large majority of people carry mobile phones, with the mobile phones being platforms for communication, information access, entertainment, productivity, social connections, and so on. To facilitate these aspects, a variety of mobile applications (commonly known as “apps”) have been developed. Examples of mobile applications include personal applications such as social media, video recording and playback, audio recording and playback, etc.; and business applications such as calendar, business communications, stock trading, etc.

One business application for mobile devices is employee time tracking. Employers have been providing applications that employees can install on their mobile devices and use the installed applications to log in her/his worked hours. A major benefit of these applications is convenience: the employees enter the work hours without the hassle of going to separately maintained, dedicated time entry computers. The employer benefits by not having the added expense of maintaining these standalone time entry computers.

Despite the convenience, currently available mobile device applications for time tracking have several technical shortcomings. Generally, the user interfaces are passive-heavily reliant on the user to enter all the information manually. For example, the existing user interfaces just provide fields for entering hours alongside the fields for entering description of the work done during those hours, all being manually entered. Therefore, apart from the convenience of availability, the conventional applications do not provide much technical advantage over the fixed, desktop computer-based time entry systems.

As such, a significant improvement for user interfaces of mobile device time tracking applications is desired.

### SUMMARY

Embodiments disclosed herein solve the aforementioned technical problems and may provide other technical solutions as well. In one or more embodiments, a mobile device application for time tracking provides a dynamic display that automatically populates (“auto-populates”) descriptions (e.g., a job description, a task description) for the hours to be entered. For instance, when a user clocks-in using the application, an auto-population engine executed by the mobile device analyzes the history of time entries by the user and generates a list of likely descriptions for the current entry. The list is displayed as selectable objects. When the user selects an object, the corresponding description is automatically added for the current time entry. The generated list may be based on information associated with the current time entry (e.g., time of day, location, etc.) and historical patterns of time entries. One or more machine learning models may be used to learn the historical patterns.

### BRIEF DESCRIPTION OF THE DRAWINGS

FIG. 1 shows an example of a system configured for automated mobile time tracking based on the principles disclosed herein.

FIG. 2 shows a flow diagram of an example method of automated mobile time tracking based on the principles disclosed herein.

FIG. 3A-3D shows example graphical user interfaces (GUIs) based on the principles disclosed herein.

FIG. 4A-4D shows other example GUIs based on the principles disclosed herein.

FIG. 5 shows a block diagram of an example computing device that implements various features and processes based on the principles disclosed herein.

### DETAILED DESCRIPTION OF SEVERAL EMBODIMENTS

One or more embodiments disclosed herein provide a significant improvement over conventional, passive mobile device time entry systems. Compared to the manual entry of a time entry description, e.g., describing a job performed for a given time entry, an auto-population engine automatically generates a set of likely descriptions. The set is displayed as selectable objects in a GUI of a time tracking application. The user can conveniently select a desired description from the displayed set to be assigned to a current clocked-in session.

The set of likely descriptions is generated from historical time entries and current parameters for the time entry. The historical time entries exhibit patterns in, for example, locations from where the time is entered, time stamps for clock-ins and clock-outs, sequence of jobs, and or any other type of historical patterns. In some instances, machine learning models may be used to learn the historical patterns. The current parameters for the time entry include, for example, current location, current time of day, current day of the week, and or any other current parameters.

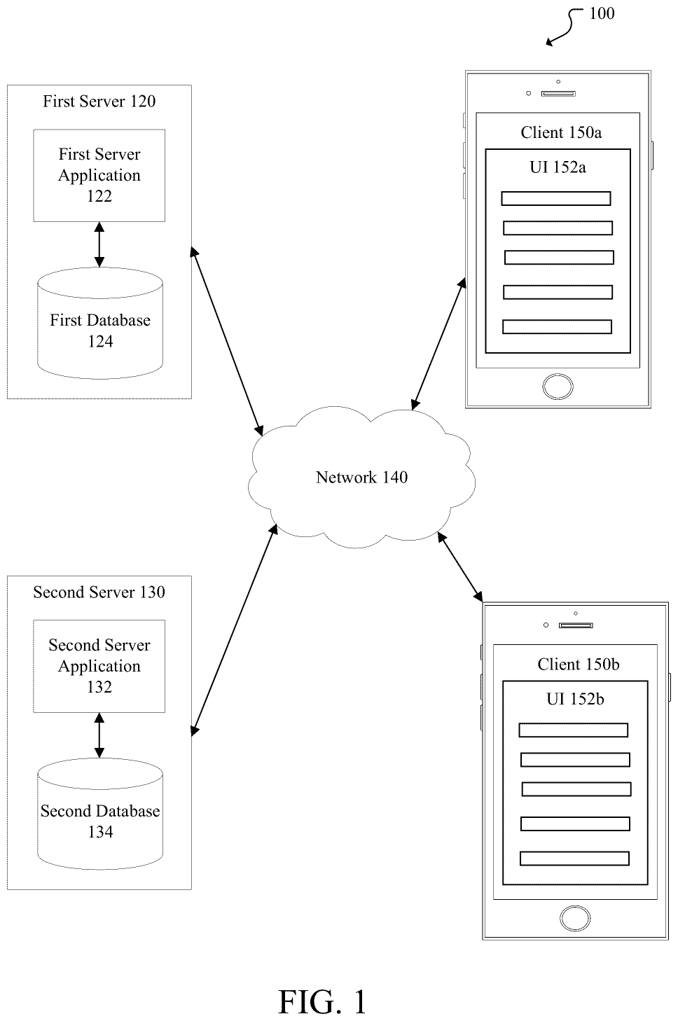

FIG. 1 shows an example of a system 100 configured for automated mobile time tracking based on the principles disclosed herein. It should be understood that the components of the system 100 shown in FIG. 1 and described herein are merely examples and systems with additional, alternative, or fewer number of components should be considered within the scope of this disclosure.

As shown, the system 100 comprises client devices 150a, 150b (collectively referred to herein as “client devices 150”) and servers 120, 130 interconnected by a network 140. The first server 120 hosts a first server application 122 and a first database 124 and the second server 130 hosts a second server application 132 and a second database 134. The client devices 150a, 150b have user interfaces 152a,152b, respectively, (collectively referred to herein as “user interfaces (Uls) 152”), which may be used to communicate with the server applications 122, 132 using the network 140. The user interfaces 152 can be displayed by a time tracking application running on the client devices 150. The server applications 122, 132 may include auto-population engines that provide one or more selectable lists to the time tracking applications. Alternatively, the time tracking applications on the client devices 150 may be stand-alone applications with all the functionality running locally without the involvement of the server applications 122, 132. Therefore, it should be understood that the embodiments described herein can be implemented at the client level, at the server level, or any combination of the two levels.

Communication between the different components of the system 100 is facilitated by one or more application programming interfaces (APIs). APIs of system 100 may be proprietary and or may include such APIs as Amazon© Web Services (AWS) APIs or the like. The network 140 may be the Internet and or other public or private networks or combinations thereof. The network 140 therefore should be understood to include any type of circuit switching network, packet switching network, or a combination thereof. Non-limiting examples of the network 140 may include a local area network (LAN), metropolitan area network (MAN), wide area network (WAN), and the like.

Client devices 150 may include any device configured to present user interfaces (Uls) 152 and receive user inputs, e.g., time entries. The Uls 152 are generally graphical user interfaces (GUls). The time entries can be based on starting, pausing, and ending a timer. Alternatively, the time entries can be based on the user's times of clock-in and clock-out. The Uls further receive descriptions associated with the time entries. The descriptions may be selected by the user from an automatically populated selectable list of descriptions.

First server 120, second server 130, first database 124, second database 134, and client devices 150 are each depicted as single devices for ease of illustration, but those of ordinary skill in the art will appreciate that first server 120, second server 130, first database 124, second database 134, and or client devices 150 may be embodied in different forms for different implementations. For example, any or each of first server 120 and second server 130 may include a plurality of servers or one or more of the first database 124 and second database 134. Alternatively, the operations performed by any or each of first server 120 and second server 130 may be performed on fewer (e.g., one or two) servers. In another example, a plurality of client devices 150 may communicate with first server 120 and or second server 130. A single user may have multiple client devices 150, and or there may be multiple users each having their own client devices 150.

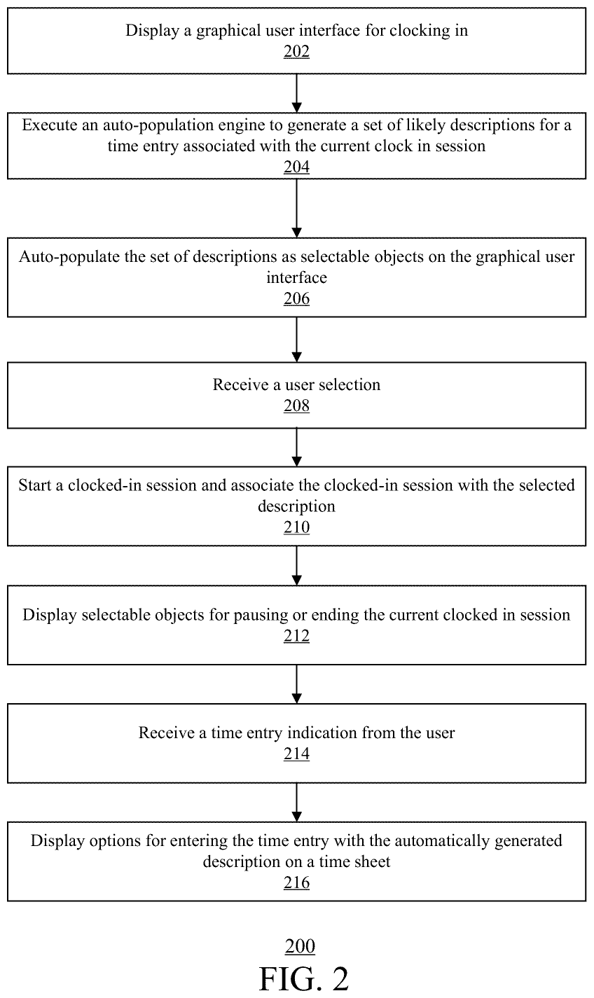

FIG. 2 shows a flow diagram of an example method 200 of automated mobile time tracking based on the principles disclosed herein. It should be understood that the steps of the method 200 are merely intended as examples and should not be considered limiting. Furthermore, the illustrated sequence of steps is used explanation purposes, and should not be considered limiting. That is, methods with additional, alternate, of fewer number of steps should also be considered within the scope of this disclosure. One or more steps of the method 200 may be performed by one or more components of the system 100 shown in FIG. 1.

The method 200 begins at step 202, where a graphical user interface (GUI) for clocking in is displayed (e.g., the user has started her/his workday, returned from a break, etc.). As further described below, the GUI may be in a “time clock” view showing a clock or a “timesheet” view showing the user's previously entered timesheets. The GUI includes a selectable object (e.g., a selectable “clock-in” button) to indicate that a user desires to clock-in. The selectable object can be provided as a floating button within the GUI.

At step 204, an auto-population engine is executed to generate a set of likely descriptions for a time entry associated with the current clock-in session. The auto-population engine may execute at a device providing the GUI (e.g., a mobile device) or at a server that the device is communicating with. Alternatively, the auto-population engine may execute at a combination of the device and the server, i.e., a subset of the functionality is executed by the mobile device and another subset is executed by the server. Some non-limiting example heuristics implemented by the auto-population engine are described below.

In one or more embodiments, the auto-population engine may generate the descriptions based on the time of the day. That is, the user may work at a business establishment during the morning and perform deliveries for the business during the afternoon. Accordingly, if the user clocks in during the morning, the descriptions may describe jobs/tasks associated with the business establishment; and if the user clocks in during the afternoon, the descriptions may describe jobs/tasks associated with the deliveries. As used herein, a job is a general term and a task is a specific term, e.g., a “donut shop” indicates a collection of tasks, e.g., being a cashier at the donut shop.

In one or more embodiments, the descriptions may be based on the day of the week. The user may be at different locations (e.g., business establishment, out in the field, etc.) depending on the day of the week, and the descriptions may reflect this diversity of work. For instance, the user may be at the business establishment on Mondays, Wednesdays, and Thursdays and the descriptions during these days may be ones for jobs/tasks typically associated with the business establishment. The user may be outside the business establishment on Tuesdays and Fridays (e.g., meeting clients, performing field work), and the descriptions may accordingly describe the typical outside business establishment jobs/tasks during Tuesdays and Fridays.

In one or more embodiments, the descriptions may be based on the location of the mobile device. For example, an employer may have multiple business locations, where each business location is associated with a particular set of jobs/tasks. A donut shop has a different set of jobs/tasks than a corporate office. Therefore, the set of descriptions will differ based on the user's location.

In one or more embodiments, the descriptions may be based on the recent work history for the user. For example, the descriptions may include the three most or five most jobs/tasks performed.

In one or more embodiments, the descriptions may be based on one or more machine learning models that learn patterns of the user's time entry behavior. Any kind of machine learning model may be used. For example, clustering models (e.g., hierarchical clustering, centroids-based clustering, distribution-based clustering, density-based clustering, fuzzy-clustering, etc.) may be used. In other examples, decision trees, e.g., simplified decision trees, boosted decision trees, etc. may be used. The patterns learned by the machine learning models may include, for example, jobs/tasks associated with the day of the week, time of the day, location, etc. The patterns may further include how the jobs/tasks are sequentially organized, i.e., what type of jobs/tasks would likely follow a job/task or a set of jobs/tasks. Additionally, the learned patterns may also comprise the work behavior of other co-workers. Therefore, any kind of machine learning models that learn the time entry behavior and generate descriptions based on the learned behavior should be considered within the scope of this disclosure.

It should further be understood that the above are just some example heuristics that the auto-population engine may implement to generate the set of likely descriptions, and any kind of heuristic should be considered within the scope of this disclosure.

At step 206, the set of descriptions are auto-populated as selectable objects on the GUI. For example, an overlay containing the selectable objects is generated on the GUI. The selectable objects are generally text descriptions that the user can select, e.g., by using a finger or a stylus on a touchscreen device and or by using a pointing or other device on the mobile device.

At step 208, a user selection is received. The user selection may indicate that one of the displayed selectable objects has been selected. Alternatively, the user selection may indicate that the user has not selected any of the displayed selectable objects. When the selection indicates that the user is not using any of the displayed selectable objects, the method 200 may provide another list of selectable objects on the GUI. Additionally or alternatively, the user may be prompted to enter the description manually.

At step 210, a clocked-in session may be started. Additionally, the clocked-in session may be associated with the selected description. The clocked-in session may display a timer indicating the time elapsed since the clock-in and also the selected description to indicate the job/task being performed.

At step 212, selectable objects for pausing or ending the current clocked-in session may be displayed. These selectable objects may be floating icons, i.e., the icons that are overlaid on the other information displayed on the GUI.

At step 214, a time entry indication may be received from the user via the GUI. The time entry indication may be based on the user's interaction with the selectable objects displayed in step 212. For example, in case of the user selecting the object for ending the current clocked-in session, it may be an indication that the user's work is done and the time is ready to be entered.

At step 216, options for making the time entry into a time sheet with the automatically generated description may be displayed on the GUI. In one or more implementations, the options may allow the user to retroactively adjust time entries. For example, the user may arrive at a work location, but did not start the clocked-in session immediately and started the session later in the day. As a displayed option, the user can retroactively adjust the clocked-in session from the time the user arrived at the work location.

Therefore, using the method 200, time entries using mobile devices may be significantly automated. The user will not have to go through the hassle of manually entering time and corresponding descriptions every single time. Examiner GUIs generated during the execution of the method are described below.

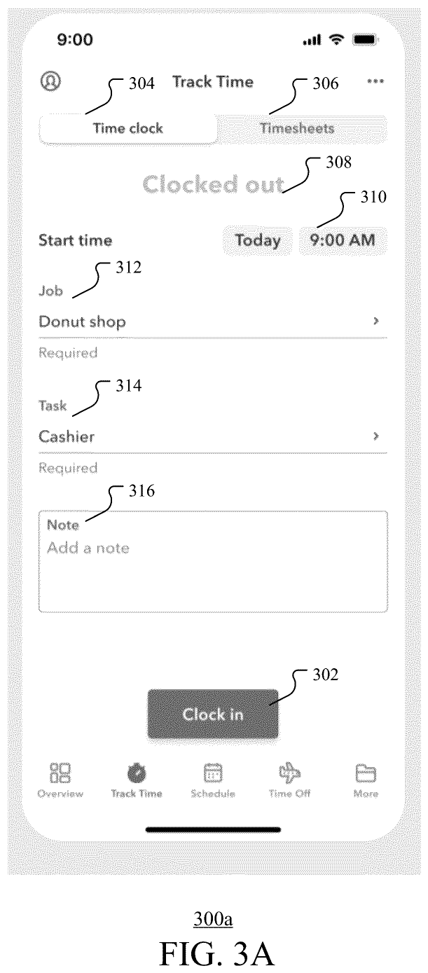

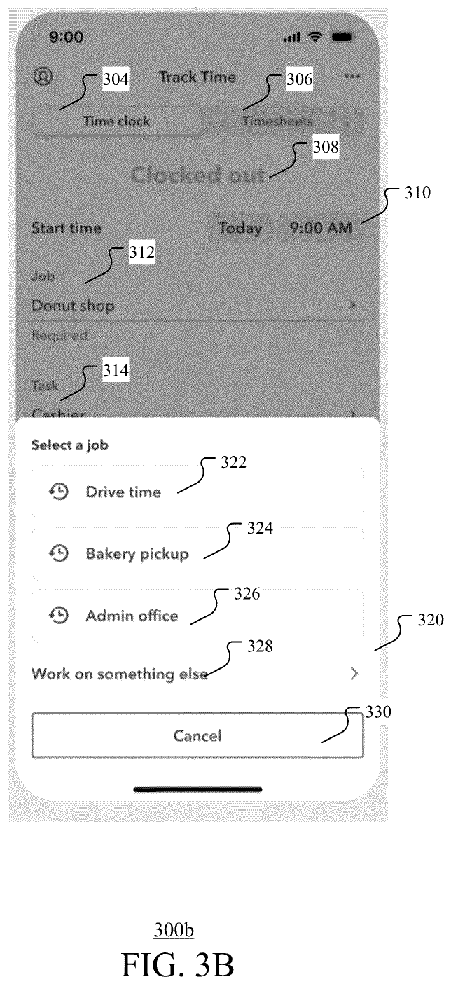

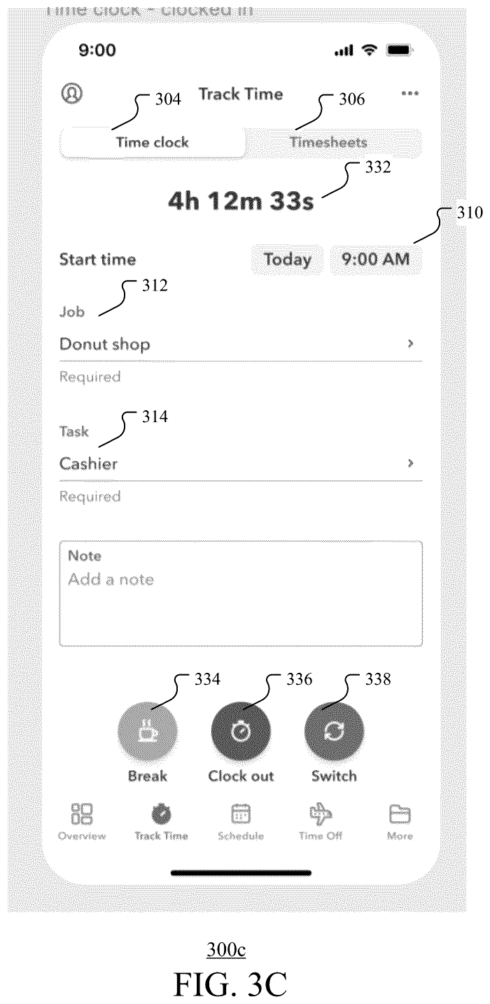

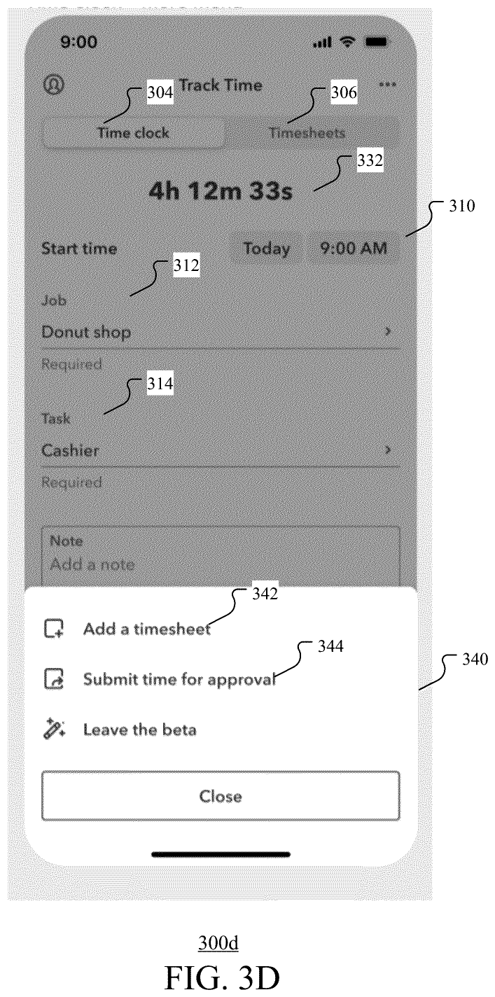

FIG. 3A-3D shows example GUIs 300a-300d based on the principles disclosed herein. The GUIs 300a-300d are generated at the client devices 150 during the execution of the method 200. The illustrated GUIs 300a-300d display a “time clock view” in accordance with the disclosed principles.

A first GUI 300a as shown in FIG. 3A is displayed when a user opens the mobile time tracking application. As shown, the GUI 300a provides a floating button 302, which the user can select to clock-in and start a timer for the work currently being performed. A time clock tab 304 indicates that the current view is the time clock view and not a timesheets view (discussed below), as indicated by a greyed-out timesheets tab 306. The GUI 300a further includes a clocked-out indication 308 alerting the user that she/he is not yet on the clock. The GUI 300a also shows the current start time 310 of the session if the user clocks in using the clock in button 302. Additionally, the GUI 300a displays a job entry field 312, a task entry field 312, and a note entry field 316 for the user to enter when the user clocks in.

When the user selects the clock-in button 302 shown in GUI 300a, an updated GUI 300b as shown in FIG. 3B is generated. The updated GUI 300b still shows the active time-clock tab 304 and the greyed-out, inactive timesheets tab 306. The updated GUI 300b further shows the clocked-out indication 308, the start time 310 of the clock, the job entry field 312, and the task entry field 314.

Additionally, the updated GUI 300b displays an overlay 320 that shows likely descriptions (e.g., for the job entry field 312) for the user to select for the current clocked-in session. Generating the overlay 320 greys out one or more other fields, as shown. As shown, the example job selection options provided by the overlay 320 include “Drive time” 322, “Bakery pickup” 324, and “Admin office” 326. The illustrated overlay 320 further provides an option for “Work on something else” 328. Should none of the displayed selection options be applicable to the user, the overlay 320 also provides a cancel button 330, allowing the user to perform a manual entry.

The various selection options (e.g., 322, 324, 326) on the overlay 320 can be generated in many different ways. Some example heuristics employed by an auto-population engine to generate the selection options are described above in the description of step 204 of method 200.

Once the user selects a description on the overlay 320, or alternatively, manually enters the description, an updated GUI 300c as shown in FIG. 3C is generated. The updated GUI 300c is an “on-the-clock” GUI. As with the prior GUI 302b, the illustrated GUI 300c is still in the time clock view with the time clock tab 304 being active and the timesheets tab 306 being greyed out. The illustrated GUI 300c further shows the job 312 and the task 314 associated with the current clocked-in session, and the start time 310 for the current clocked-in session. Furthermore, the illustrated GUI 300c shows the time elapsed 332 (as shown 4 h 12 m 33 s) for the current clocked-in session.

In addition, the illustrated GUI 300c displays floating objects for the user to modify the current clocked-in session. For instance, a break object 334 allows the users to pause the current session for a break; a clock-out object 336 allows the user the end the current clocked-in session, and a switch object 338 allows the user to switch the current job or task to another job or task. The floating objects 334, 336, 338 are generally displayed on the GUI 300c throughout the clocked-in session.

When the user selects the clock-out object 336 to end the current clocked-in session, an updated GUI 300d as shown in FIG. 3D is generated. The updated GUI 300d shows an overlay 340 with selectable options for the current clocked-in session. The example options, as shown, are add a timesheet option 342, which allows the add the recent clocked-in session into a time timesheet, and submit time for approval option 344, which allows the user to submit the recent time entry for approval. Generating the overlay 340 greys out one or more other fields, as shown.

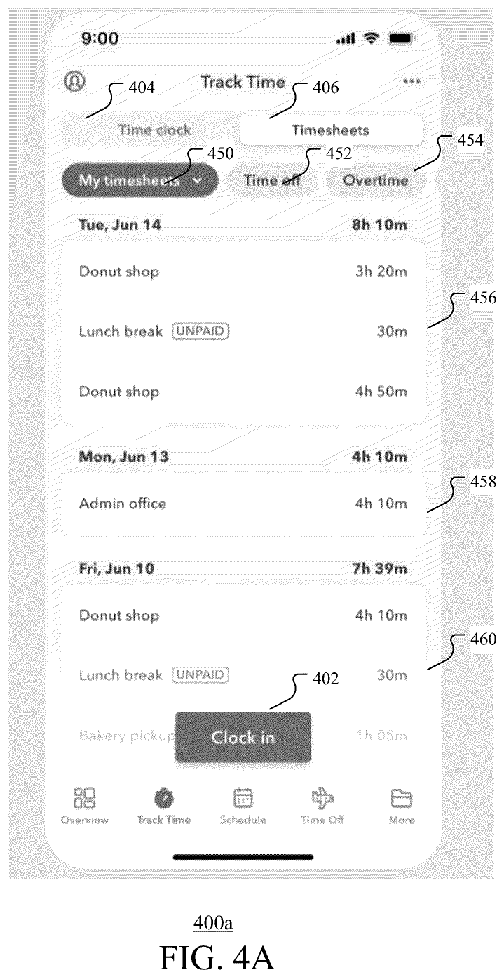

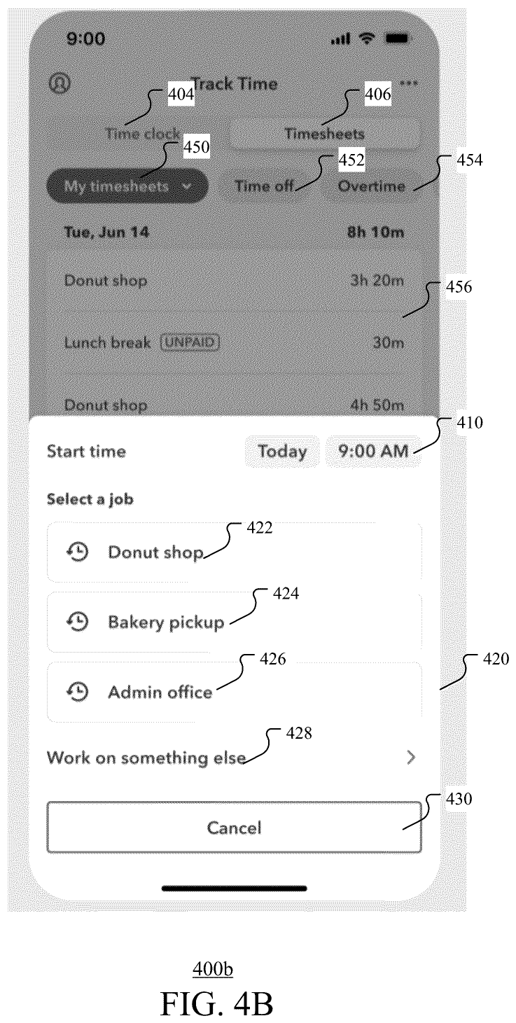

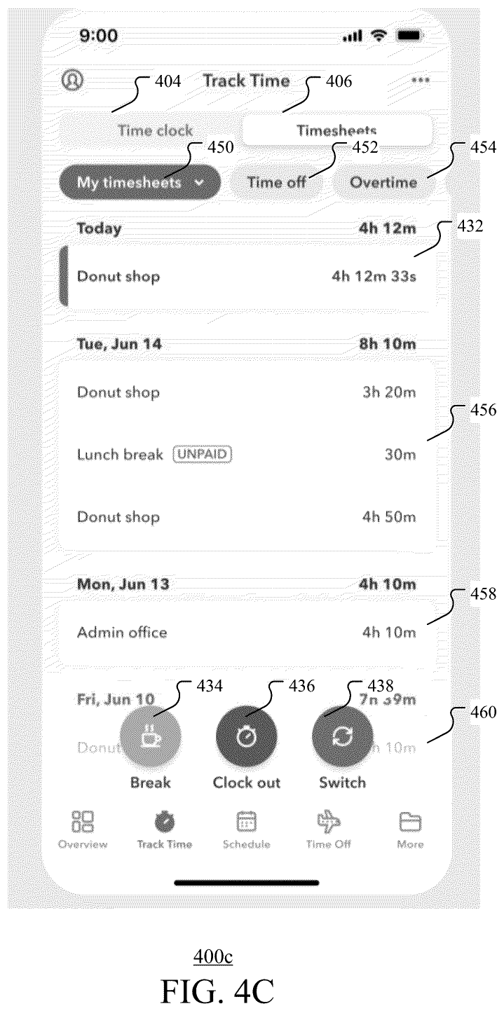

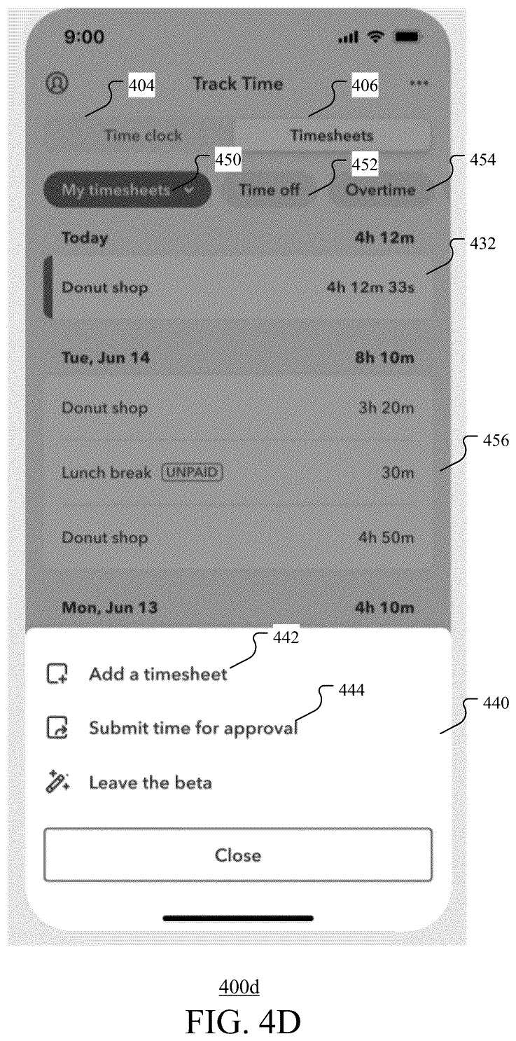

FIG. 4A-4D shows example GUIs 400a-400d based on the principles disclosed herein. The GUIs 400a-400d are generated at the client devices 150 during the execution of the method 200. The GUIs 400a-400d display a “timesheets view” in accordance with the disclosed principles.

A first GUI 400a as shown in FIG. 4A is displayed when a user opens the mobile time tracking application and has selected the time sheet selector 450. As shown, the GUI 400a provides a floating button 402, which the user can select to clock-in and start a timer for the work being performed. A timesheets tab 406 indicates that the view is the timesheets view and not the time clock view, as indicated by a greyed-out time clock tab 404. Within the illustrated timesheets view, the GUI 400a displays the user's recent timesheets 456, 458, 460. The illustrated recent timesheets 456, 458, 460 include the corresponding date, description of the work done, and any breaks taken. In addition, the GUI 400a includes a timesheet selector 450 for displaying the recent timesheets 456, 458, 460; a time off selector 450 for displaying when the user has taken time off, and an overtime selector 454 for displaying any overtime work performed by the user.

When the user selects the clock-in button 402 shown in GUI 400a, an updated GUI 400b as shown in FIG. 4B is generated. The illustrated updated GUI 400b still shows the active timesheets tab 304 and the greyed-out, inactive time clock tab 306. The illustrated updated GUI 300b further shows the timesheet selector 450 (currently selected), the time off selector 452, and the overtime selector 454. Additionally, the timesheet 456 can be seen.

The illustrated updated GUI 400b shows an overlay 420 that shows likely descriptions for the user to select for the current clocked-in session. Generating the overlay 420 greys out one or more other fields, as shown. As shown, the example job selection options provided by the overlay 420 include “Donut shop” 422, “Bakery pickup” 424, and “Admin office” 426. The overlay 420 further provides an option for “Work on something else” 428. Should none of the displayed selection options be applicable to the user, the overlay 420 also provides a cancel button 430, allowing the user to perform a manual entry.

The various selection options (e.g., 422, 424, 426) on the overlay 420 can be generated in many different ways. Some example heuristics employed by an auto-population engine to generate the selection options are described above in the description of step 204 of method 200.

Once the user selects descriptions on the overlay 420, or alternatively, manually enters the description, an updated GUI 400c, as shown in FIG. 4C, is generated. The illustrated updated GUI 400c is an “on the clock” GUI. As above, the GUI 400c is still in the timesheets view with the timesheets tab 406 being active and the time clock tab 404 being greyed out. The GUI 400c further shows a timesheet in progress 432 (as the user is still in the clocked-in mode) in addition to the recent timesheets 456, 458, 460.

In addition, the illustrated GUI 400c displays floating objects for the user to modify the current clocked-in session. For instance, a break object 434 allows the user to pause the current session for a break; a clock-out object 436 allows the user the end the current clocked-in session, and a switch object 438 allows the user to switch the current job or task to another job or task. The floating objects 434, 436, 438 are generally displayed on the GUI 400c throughout the clocked-in session.

When the user selects the clock-out object 436 to end the current clocked-in session, an updated GUI 400d shown in FIG. 4D is generated. The illustrated updated GUI 400d shows an overlay 440 with selectable options for the current clocked-in session. The example options, as shown, are add a timesheet option 442, which allows the add the recent clocked-in session into a timesheet, and submit time for approval option 444, which allows the user to submit the recent time entry for approval. Generating the overlay 440 greys out one or more other fields, as shown.

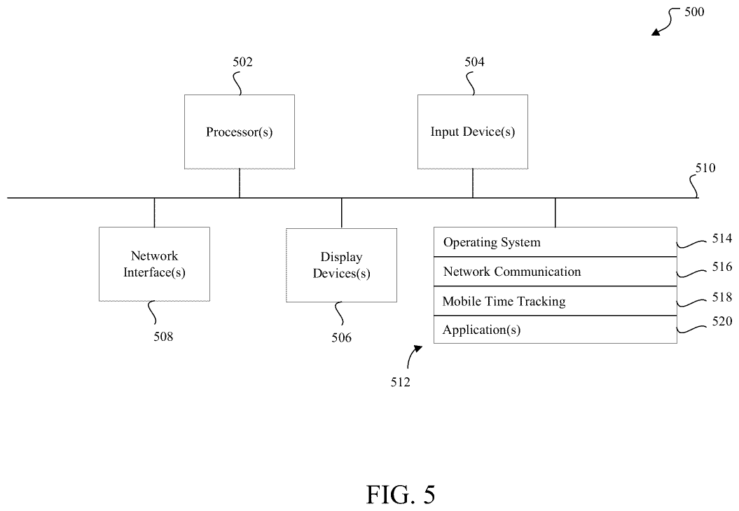

FIG. 5 shows a block diagram of an example computing device 500 that implements various features and processes, based on the principles disclosed herein. For example, computing device 500 may function as first server 120, second server 130, client 150a, client 150b, or a portion or combination thereof in some embodiments. The computing device 500 also performs one or more steps of the method 200. The computing device 500 is implemented on any electronic device that runs software applications derived from compiled instructions, including without limitation personal computers, servers, smart phones, media players, electronic tablets, game consoles, email devices, etc. In some implementations, the computing device 500 includes one or more processors 502, one or more input devices 504, one or more display devices 506, one or more network interfaces 508, and one or more computer-readable media 512. Each of these components is be coupled by a bus 510.

Display device 506 includes any display technology, including but not limited to display devices using Liquid Crystal Display (LCD) or Light Emitting Diode (LED) technology. Processor(s) 502 uses any processor technology, including but not limited to graphics processors and multi-core processors. Input device 504 includes any known input device technology, including but not limited to a keyboard (including a virtual keyboard), mouse, track ball, and touch-sensitive pad or display. Bus 510 includes any internal or external bus technology, including but not limited to ISA, EISA, PCI, PCI Express, USB, Serial ATA or FireWire. Computer-readable medium 512 includes any non-transitory computer readable medium that provides instructions to processor(s) 502 for execution, including without limitation, non-volatile storage media (e.g., optical disks, magnetic disks, flash drives, etc.), or volatile media (e.g., SDRAM, ROM, etc.).

Computer-readable medium 512 includes various instructions 514 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 504; sending output to display device 506; keeping track of files and directories on computer-readable medium 512; controlling peripheral devices (e.g., disk drives, printers, etc.) which can be controlled directly or through an I/O controller; and managing traffic on bus 510. Network communications instructions 516 establish and maintain network connections (e.g., software for implementing communication protocols, such as TCP/IP, HTTP, Ethernet, telephony, etc.).

Mobile time tracking instructions 518 include instructions that implement the disclosed process of auto-populating likely descriptions for time entries for a more efficient, dynamic time entries using a mobile device.

Application(s) 520 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method performed by a processor of a mobile device, said method comprising:
generating a graphical user interface comprising a selectable object to initiate time entry on a time tracking application;
in response to receiving a selection of the selectable object, executing an auto-population engine to determine a user-specific set of likely descriptions for the time entry based on the user's history of time entries, including a learned pattern of a sequential organization of the time entries by the user;
auto-populating the user-specific set of likely descriptions as a plurality of selectable options on a list for the user to enter the description for the time entry;
in response to receiving a selected option from the plurality of selectable options, starting a clocked-in session and associating the clocked-in session with a description corresponding to the selected option;
displaying, during the clocked-in session and on a timesheets view, a plurality of floating objects allowing the user to perform at least one of pausing the clocked-in session, ending the clocked-in session, or switching a current job to another job; and
in response to receiving a selection of a floating object of the plurality of floating objects, performing at least one of pausing the clocked-in session, ending the clocked-in session, or switching the current job to another job.

2. The method of claim 1, wherein executing the auto-population engine further comprises:
executing the auto-population engine to determine the user-specific set of likely descriptions based on a current location of the user and the user's history of time entries.

3. The method of claim 1, wherein executing the auto-population engine further comprises:
executing the auto-population engine to determine the user-specific set of likely descriptions based on a current time and the user's history of time entries.

4. The method of claim 1, wherein executing the auto-population engine further comprises:
executing the auto-population engine to determine the user-specific set of likely descriptions based on a machine learning model trained using the user's history of time entries.

5. The method of claim 1, wherein generating the graphical user interface comprises:
generating the graphical user interface in a time clock view.

6. The method of claim 5, further comprising:
displaying a timer in the time clock view of the clocked-in session.

7. The method of claim 1, wherein generating the graphical user interface comprises:
generating the graphical user interface in the timesheets view; and
displaying an ongoing timesheet in the timesheets view of the clocked-in session.

8. The method of claim 1, wherein auto-populating the user-specific set of likely descriptions comprises:
displaying an overlay with the plurality of selectable options on the graphical user interface.

9. The method of claim 1, further comprising:
receiving an indication that the clocked-in session is to be ended; and
automatically generating a timesheet with the description for the clocked-in session.

10. The method of claim 9, wherein automatically generating the timesheet comprises:
retroactively adjusting the clocked-in session in response to determining that the user did not start the clocked-in session at a proper time.

11. A system comprising:
a non-transitory storage medium storing computer program instructions; and
one or more processors configured to execute the computer program instructions to cause the system to perform operations comprising:
generating a graphical user interface comprising a selectable object to initiate a time entry on a time tracking application;
in response to receiving a selection of the selectable object, executing an auto-population engine to determine a user-specific set of likely descriptions for the time entry based on the user's history of time entries, including a learned pattern of a sequential organization of the time entries by the user, the sequential organization indicating that a first previous time entry having a first description temporally precedes a second previous time entry having a second description;
determining by the auto-population engine that the time entry temporally follows a previous time entry having the first description;
auto-populating the set of likely descriptions as a plurality of selectable options on a list for the user to enter the description for the time entry; and
in response to receiving a selected option from the plurality of selectable options, starting a clocked-in session and associating the clocked-in session with a description corresponding to the selected option;
displaying, during the clocked-in session and on a timesheets view, a plurality of floating objects allowing the user to perform at least one of pausing the clocked-in session, ending the clocked-in session, or switching a current job to another job; and
in response to receiving a selection of a floating object of the plurality of floating objects, performing at least one of pausing the clocked-in session, ending the clocked-in session, or switching the current job to another job.

12. The system of claim 11, wherein executing the auto-population engine further comprises:
executing the auto-population engine to determine the user-specific set of likely descriptions based on a current location of the user and the user's history of time entries.

13. The system of claim 11, wherein executing the auto-population engine further comprises:
executing the auto-population engine to determine the user-specific set of likely descriptions based on a current time and the user's history of time entries.

14. The system of claim 11, wherein executing the auto-population engine further comprises:
executing the auto-population engine to determine the user-specific set of likely descriptions based on a machine learning model trained using the user's history of time entries.

15. The system of claim 11, wherein generating the graphical user interface comprises:
generating the graphical user interface in a time clock view.

16. The system of claim 15, wherein the operations further comprise:
displaying a timer in the time clock view of the clocked-in session.

17. The system of claim 11, wherein generating the graphical user interface comprises:
generating the graphical user interface in the timesheets view; and
displaying an ongoing timesheet in the timesheets view of the clocked-in session.

18. The system of claim 11, wherein auto-populating the set of likely descriptions comprises:
displaying an overlay with the plurality of selectable options on the graphical user interface.

19. The system of claim 11, wherein the operations further comprise:
receiving an indication that the clocked-in session is to be ended; and
automatically generating a timesheet with the description for the clocked-in session.

20. The system of claim 19, wherein automatically generating the timesheet comprises:
retroactively adjusting the clocked-in session in response to determining that the user did not start the clocked-in session at a proper time.
